(19) United States
(12) Patent Application Publication
(10) Pub. No.: US 2007/0275803 A1
(43) Pub. Date: Nov. 29, 2007

(54) GUIDING AND TENSIONING DEVICE FOR CHAIN DRIVES

(75) Inventor: Hans-Walter Wodtke, Werdohl (DE)

Correspondence Address: VOLPE AND KOENIG, P.C., UNITED PLAZA, SUITE 1600, 30 SOUTH 17TH STREET, PHILADELPHIA, PA, 19103, US

(73) Assignee: AFT ATLAS FAHRZEUGTECHNIK GMBH, Werdohl (DE)

(21) Appl. No.: 11/751,814

(22) Filed: May 22, 2007

(30) Foreign Application Priority Data
May 23, 2006 (DE) 102006024082.0

(51) Int. Cl. F16H 7/08; F16H 7/18

(52) U.S. Cl. 474/111; 474/140

(57) ABSTRACT

A guiding and tensioning device for chain drives in vehicles is provided, having a guiding and tensioning element that can be fastened at a supporting part (4) of the vehicle and can be brought into an effective contact with the chain (1) of the chain drive. The device is provided as a rail (2) arranged in a plane of the chain drive and supported at the carrying part (4), which in order to reduce oscillations created by the chain drive can be acted on by at least one actuator with a force acting in the direction of the chain. In order to effectively and permanently suppress chain whining in such chain drives, the rail (2) is provided as a carrier supported on two supports. One support is formed by a drag bearing (3) arranged on the supporting part (4) in a locally fixed manner and the other support is a movable support (8) on the rail (2), which can be displaced in the longitudinal direction. At least one actuator (6a, 6b, 6c, 6d) is arranged between the supports and engages the rail (2). The rail (2) is flexible so that an elastic bending thereof is possible in the plane of the chain drive.

### FIELD OF THE INVENTION

The invention relates to a guiding and tensioning device for chain drives in vehicles, comprising a guiding and/or tensioning element fastened at a supporting part of the vehicle, which can be brought into an effective contact with the chain of the chain drive, with the device being formed by a rail, movably arranged in the plane of the chain drive and resting on a supporting part, which can be impinged with a force acting in a direction of the chain by at least one actuator in order to reduce the oscillations created by the chain drive.

### BACKGROUND OF THE INVENTION

Chain drives are used in vehicles in particular, in order to drive a camshaft of an internal combustion engine via a crank shaft, for example, which opens and closes the inlet and/or exhaust valves thereof. Such a chain drive is known for example from DE 199 08 287 A1.

By the polygonal motion of the chain in a chain drive, radial and tangential, periodically changing forces develop at the chain, the sprockets, as well as the allocated guiding and tensioning elements associated to the respective oscillations of the respective parts. The oscillating forces are introduced into the structure supporting the chain drive and, among other things, lead to noise called chain-whining.

In order to counteract this problem a number of passive measures are known, such as for example elastically supported guiding and/or tensioning rails, rubberized sprockets, sprockets with flywheels, and the like. These solutions known per se can certainly have positive effects on the fight against the chain-whining noise mentioned above; however, these devices have shown little practical effectiveness and a limited life with negative consequences in reference to the dynamic of the chain drive, as well as an increased need of construction space.

Furthermore, less noisy chain types are used, such as roller chains or toothed chains, however their production leads to higher costs, and a negative wear behavior can be observed.

However, from DE 199 59 521 A1 a dynamically controlled guiding and tensioning device for infinite drives is known, such as a control drive of an internal combustion engine, as well as a method for its operation. Essentially here a dynamically addressed actuator is used in form of a piezo actuator, by which a fixed, bar-shaped tensioning element can be displaced opposing a tensile means of the infinite drive. Addressing the piezo actuator occurs depending on operating parameters of the internal combustion engine.

### SUMMARY

In light of this background the object of the invention is to provide a further improved guiding and tensioning device of a generic type, which effectively prevents or at least reduces chain-whining in chain drives.

The invention relates to a guiding and tensioning device for chain drives of vehicles according to the features of the primary claim, having a guiding and tensioning element that can be fastened at a supporting part of the vehicle and can be brought into effective contact with the chain of a chain drive, with the device being formed by a rail, arranged mobile in the level of the chain drive and supported on the supporting part, which can be impinged with a force acting in the direction of the chain via at least one actuator in order to reduce the oscillations created by the chain drive. In order to attain the stated objective, it is additionally provided for the rail to be embodied in the form of a carrier supported on two supports, that one of the supports is formed by a drag bearing, arranged in a locally fixed manner at the opposing part, and the other support by a movable support allowing the displacement of the rail in a longitudinal direction such, that at least one rail actuator is arranged between the two supports, engaging the rail, and that the rail is embodied in a flexible fashion such that it can flexibly bend in the plane common with the chain drive.

The general concept of the invention essentially comprises for the rail to be embodied flexible in its entirety such that by using one or more actuators, active additional periodic forces can be introduced to the chain drive partially or entirely compensating the acoustically relevant effect of the polygonal forces resulting from the running of the chain of the chain drive. Additionally, largely independent from the deflection of the actuator, the rail is almost ideally contacting the respectively adjusting curvature of the chain resulting in an improved guidance of the chain as well as an optimum transfer of the oscillation from the actuator thereto. The coupling of the chain improves the stronger the actuator alignment can be implemented in a change of the encircling path. This is stronger in a stiff body displacement of the rail and/or a rotation of the rail around an end than in a central bending of the rail. Another advantage to be observed by the inert elasticity of the rail is an additional dampening effect. The relative displacements occurring as a consequence of the elasticity at the support sites cause a particular dampening.

Further developments or embodiments of the invention are described below.

Preferably, the rail is formed from metal and/or plastic. In an embodiment made from metal, the rail has a low-wear surface at the side facing the chain.

Preferably, the running surface of the rail facing the chain, seen in the traveling direction thereof, is formed convexly and is in a direct effective contact with the chain of the chain drive.

With regard to at least one actuator affecting the rail, the invention provides that it is formed by a piezoelectric structure. According to a certain variant of the invention, at least one actuator is embodied as a piezo-linear actuator. Such a piezo linear actuator is supported, at the one end, on the mentioned supporting part of the vehicle and, at the other end, on the rail.

According to another variant, it is provided that the linear piezo actuator is, on the one end, connected to the rail in a fixed manner and, on the other end, carries a seismic mass.

Another variant provides for at least one actuator to be embodied as a flexible piezo/metal actuator or an elastic piezo actuator. For example, such a flexible piezo/metal actuator or elastic piezo actuator is embedded in the rail or adhered thereto.

Furthermore, it is preferably provided that at least one actuator is arranged inside a fully-active feedback circuit and can be controlled by an allocated control device. The control signals of said control device may be provided by the latter for controlling the at least one actuator, depending on actual oscillations inserted by the operation of the chain traveling in the chain drive as well as determined by sensors.

Additionally, the guiding and tensioning device according to the invention is provided with at least one sensor for determining the oscillations, introduced by the operation of the chain in the chain drive, having the form of an oscillation and accelerator sensor. The oscillation and /or acceleration sensor may here preferably be a piezoelectric oscillation and/or accelerator sensor with a seismic mass. Furthermore the invention includes the possibility of at least one actuator both in a force creating as well as sensing manner.

Additionally it may be provided that at least one actuator, acting as a dampening element (shunted piezo) or as an oscillation absorber (tuned piezo), can be passively or semi-actively switched or be switch-controlled via the control device mentioned.

The invention further includes a guiding and tensioning device, in which the rail is cantilevered. The cantilever rests on two supports and is provided with a protruding elastically deforming and/or flexible end in the area of one support. This rail structure allows an improved coupling of the rail to the chain and thus an optimal ratio between the chain path extension and the adjustment path of the actuator.

Finally, according to the invention it is provided for the rail to be allocated to an actuator as well as a tensioning device.

### BRIEF DESCRIPTION OF THE DRAWINGS

In the following, the invention is explained in greater detail using exemplary embodiments shown in the attached drawing. Shown are:

FIG. 1 a schematic view of a guiding and tensioning device for chain drives according to prior art, and

FIGS. 2 to 5 schematic views of guiding and tensioning devices according to the invention.

### DETAILED DESCRIPTION OF THE PREFERRED EMBODIMENTS

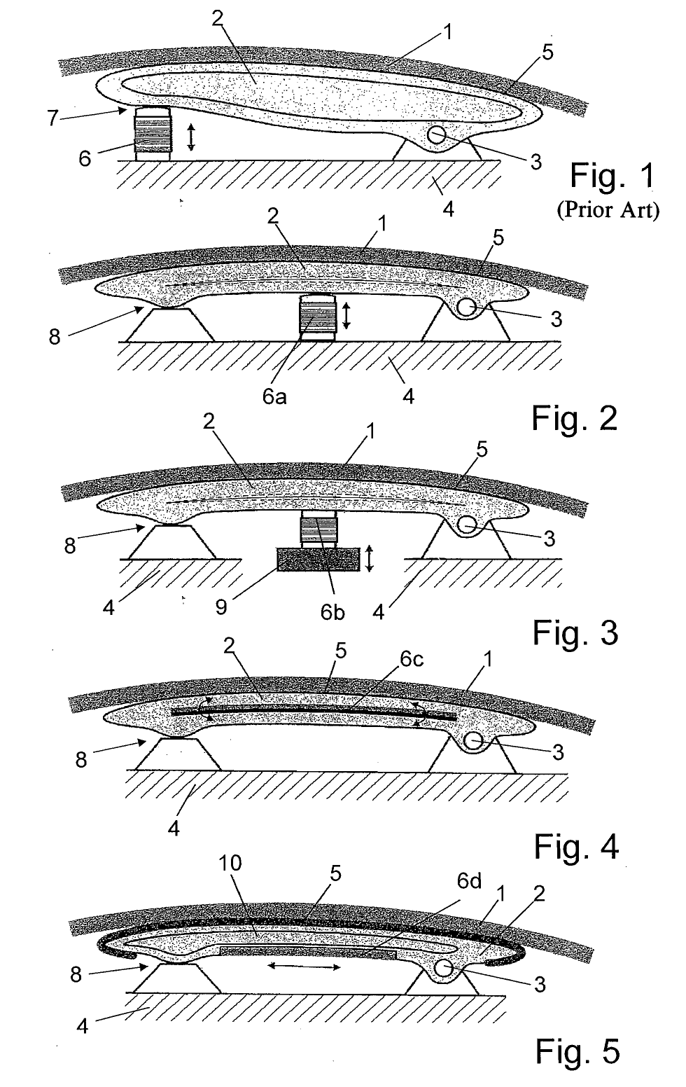

FIG. 1 shows a selected section of a chain 1 of the chain drive of a vehicle in the immediate proximity of a guiding and tensioning device known per se, with the chain 1 realizing the connection between, for example, a crank shaft and a camshaft of an internal combustion engine of a vehicle driven thereby (here, see particularly DE 199 59 521 A1).

Here, the guiding and tensioning device comprises a guiding element in the form of a rail 2, which is arranged pivotably around a drag bearing 3 and is supported on a supporting part 4, for example a supporting part 4 of the motor and/or transmission housing. The rail 2 is formed by a stiff body and primarily comprises metal and/or plastic. Further, the rail 2 is provided with a resistant running surface 5 in for direct effective contact with a chain 1 of the chain drive. In order to fully or at least partially compensate the acoustically relevant effect of the forces developing during the polygonal travel of the chain 1, already described in greater detail, and/or to allow influencing of the tension of the chain 1 of the chain drive, an actuator 6 is provided, which, in addition to the above-mentioned drag bearing 3, represents a second support 7 of the rail 2. The actuator 6 mentioned is supported on the supporting part 4 and is suitable to displace the rail 2 in the form of a stiff body against the chain 1 of the chain drive, depending on the control signals of a control device, not shown here.

A guiding and tensioning device according to FIG. 2 that is in accordance with the present invention differs from prior art according to FIG. 1 in that the rail 2 is embodied supported on two supports like a carrier, namely such that the support occurs by the drag bearing 3, arranged at the carrying part 4 in a locally fixed manner, and the other support is formed by a movable support 8 allowing displacement in the longitudinal direction of the rail 2.

At least one actuator 6a engaging the rail 2 is arranged between the drag bearing 3 and the movable support 8, which is formed by a piezoelectric structure. Piezoelectric structures have a high stiffness and speed with regard to forming counterforces and/or counter impulses necessary for the present application.

In the present case, at least one actuator 6a is embodied as a linear piezo actuator fastened to the carrying part 4 and on the other end engaging the rail 2 at the side opposite the chain 1. Additionally, the actuator 6a is connected via a control line to the respective control device, not shown, here, which may be a motor control device, for example. Using at least one actuator 6a, the rail 2 can be actively impinged with a periodic or non-periodic force such that forces and/or oscillations created by the operation of the chain drive and also introduced into the rail 2 can at least partially be compensated.

Essentially it is provided, here, that counter impulses and/or counter forces are created by the actuator 6a against the oscillation direction of the rail 2, which reduce the original oscillation amplitudes of the rail 2 and, if applicable, also neighboring parts of the chain drive, or in the best case scenario neutralize them entirely. For example, via the at least one actuator 6a oscillations are created, with the oscillations being dephased by approx. 180° in reference to the oscillations introduced to the rail 2, which interfere with the oscillations introduced into the rail 2 by the chain and thus eliminate them.

In order to ensure, independent from the respective deflection of the actuator 6a, a guidance of the chain 1 as ideal as possible as well as a transfer of the oscillation from the actuator 6a to the rail 2 and the chain 1, the rail 2 is formed in a particularly beneficial manner as flexible within certain limits such that an elastic bending thereof is possible within a plane common with the chain drive.

“Flexible within limits” means here, in particular, that the rail 2, on the one hand, can effectively transfer the deflection of the actuator 6a to the chain 1. Additionally, within the scope of an elastic bending and independent from the deflection of the actuator 6a the contact in the area of the movable support 8 between the rail 2 and the supporting part 4 shall remain, with one end of the rail 2 being pressed against the supporting part 4 (movable support 8) by the chain 1, however a motion of said free end being possible in the longitudinal direction. By this measure the rail 2 and the chain 1 largely contact each other in an ideal fashion, which also ensures a comfortable guidance of the chain 1.

Here, the running surface 5 of the rail 2 is formed convex towards the chain 1 and seen in the travel direction thereof, which advantageously supports the desired functionality of the rail 2 according to the invention with regard to the guidance of the chain 1. As already mentioned, an additional dampening effect can also be observed by the flexible embodiment of the rail 2 provided.

Similar to the exemplary embodiment according to FIG. 2, in FIG. 3 an actuator 6b is shown in the form of a linear piezo actuator, which, on the one end, is suspended in a fixed manner on a rail 2 flexible within limits, and, on the other end, carries a freely suspended seismic mass 9. It is therefore suitable to create counter impulses and/or counter forces against the seismic mass 9 and thus to contribute to the compensation of oscillations originating in the chain drive. As a result a reduction of noise created by the chain drive is achieved.

Furthermore, FIG. 4 shows a rail 2 of a chain drive, which is also flexible within certain limits and preferably comprises plastic. Inside the rail 2, an actuator 6c known per se is arranged in the form of a so-called flexible piezo/metal actuator, which was preferably embedded and/or molded therein already during the production of the rail 2, which themselves are suitable to create the counter impulses and/or counter forces. By such an arrangement of the actuator 6c and/or embodiment of the rail 2, defined flexible bending can be created therein, which is suitable according to the invention to create the counter impulses and conterforces mentioned. In an activation of the actuator 6c, a momentum effect inside the rail 2 is therefore to be observed, which in turn causes a change in bending of the running surface 5 of the rail 2. This change in bending of the running surface 5 is suitable to act against the oscillations originating at the chain 1 which create noise and at least partially to reduces them.

Finally, FIG. 5 shows a rail 2, which can also be elastically bent within certain limits and comprises plastic, however it is additionally provided with an embedded reinforcement 10, for example made from metal. Here, an expanding piezo actuator 6d is arranged in a fixed manner on the surface of the rail 2 such that it points away from the chain 1. Preferably the expanding piezo actuator 6d is adhered to the rail 2 for this purpose. The expanding piezo actuator 6d is suitable and intended to act a force in the longitudinal direction on the rail 2 such that the oscillations introduced by the chain 1 into the rail 2 can at least be compensated. Additionally, by this arrangement the chain drive overall can be calmed such that a chain whining described at the outset does not develop. The rail 2 according to FIG. 5 can alternatively also be made from metal, with the actuator 6d being inserted and/or adhered in a recess. A plastic coating is located at the side of the chain.

The exemplary embodiments according to FIGS. 2 through 5 particularly target guiding and tensioning devices, which can exclusively be operated by one or more actuators 6a through 6d. However, included in the scope of the invention are also guiding and tensioning devices, in which at least one actuator 6a through 6d is allocated to a chain tightener, arranged in line and known per se, not shown in greater detail here, and which can be mechanically stressed, for example by a spring force or hydraulically.

Sometimes, based on above-described design structures of the guiding and tensioning device, the pure pivoting bearing 3 shown in FIGS. 2 through 5 can be omitted, because only small pivotal motions have to be realized, which to a certain extent are possible by the flexible embodiment of rail 2. Thus, in context with the invention described here, the term “pivotable bearing 3” includes all such bearing sites, which allow the further transfer of forces created by the linear piezo actuator 6a through 6d in an oscillation and/or noise reducing manner.

The at least one actuator 6a through 6d is preferably part of a fully activated feedback circuit, not shown in greater detail, and therefore can be controlled by a control device already mentioned. Therefore, it is provided that the necessary control signals for controlling at least one actuator 6a through 6d are preferably provided depending on actual oscillations introduced by the operation of the chain traveling in a chain drive as well as determined by sensors.

Oscillation and/or acceleration sensors are suggested as suitable sensors, preferably an piezoelectric oscillation and/or acceleration sensor with a seismic mass, as already being used in the exemplary embodiment according to FIG. 3 as the actuator 6b. Such a sensor can be arranged at the rail 2 itself or other suitable oscillation impinged parts of the chain drive. Depending on the type of sensor used it is additionally recommended that it be arranged separate from the system, for example as a microphone in the passenger cabin.

It is also possible and included in the scope of the invention for one or more piezoelectric actuators 6a through 6d to be used, which in turn are embodied either in an oscillation creating manner or as sensors (not shown in greater detail).

Further, it is possible that at least one actuator 6a through 6d, acting as a dampening element (shunted piezo) or as an oscillation absorber (turned piezo), can be passively or semi-actively switched or be switch controlled, with sometimes an automatic rotation adjustment of the chain drive may be provided.

With respect to the energy supply of at least one actuator 6a through 6d and perhaps the piezoelectric sensor they may be provided with an external energy supply. On the other hand, they may also be embodied self-supplying with electric energy by deforming piezo element structures due to potential oscillations, resulting form the radial and tangential force variations at the chain 1 and the rail 2 by the polygonal travel of the chain 1 in the chain drive.

### LIST OF REFERENCE CHARACTERS

1 Chain
2 Rail
3 Drag bearing
4 Supporting part
5 Running surface (rail 2)
6 Actuator (prior art)
6a-6b Actuator (invention), piezo actuator
7 Support
8 Movable support
9 Seismic mass
10 Reinforcement

1. A guiding and tensioning device for chain drives of motor vehicles, having a guiding and tensioning element that is fixed at a supporting part of the vehicle and can be brought into an effective contact with a chain of the chain drive, with the device comprising a rail supported by the supporting part and arranged for movement in a plane of the chain drive, the rail being acted upon with a force by at least one actuator in a direction of the chain for reducing oscillations created by the chain drive, the rail comprises a carrier resting on two supports, one of the supports is formed by a drag bearing arranged in a locally fixed manner on the supporting part and the other of the supports is a movable support that allows a displacement in a longitudinal direction of the rail, the at least one actuator is arranged at the rail between the two supports and the rail is flexible such that an elastic bending thereof occurs within the plane of the chain drive upon actuation of the at least one actuator.

2. A guiding and tensioning device according to claim 1, wherein the rail is made from metal.

3. A guiding and tensioning device according to claims 1, wherein a running surface of the rail, that is in direct effective contact with the chain of the chain drive, is convex towards the chain and wear resistant in a chain contact area.

4. A guiding and tensioning device according to claim 1, wherein the at least one actuator is formed by a piezoelectric structure.

5. A guiding and tensioning device according to claim 4, wherein the at least one actuator is a linear piezo actuator.

6. A guiding and tensioning device according to claim 5, wherein the linear piezo actuator is supported, on one end, at the supporting part and, at the other end, on the rail.

7. A guiding and tensioning device according to claim 5, wherein the linear piezo actuator, on one end, is connected to the rail in a fixed manner and, on the other end, supports a seismic mass.

8. A guiding and tensioning device according to claim 4, wherein the at least one actuator is a flexible piezo metal actuator or an expanding piezo actuator.

9. A guiding and tensioning device according to claim 8, wherein the expanding piezo metal actuator or the expanding piezo actuator is embedded in the rail or adhered thereto.

10. A guiding and tensioning device according to claim 1, wherein the at least one actuator is part of a fully-active feedback circuit and is controlled by a control device.

11. A guiding and tensioning device according to claim 10, wherein control signals for controlling the at least one actuator are provided depending on actual oscillations caused by the operation of the chain drive and determined by at least one sensor.

12. A guiding and tensioning device according to claim 11, wherein the at least one sensor comprises using an oscillation and/or acceleration sensor that determines the actual oscillations caused by the operation of the traveling chain of the chain drive.

13. A guiding and tensioning device according to claim 12, wherein the oscillation and acceleration sensor is a piezoelectric oscillation and/or acceleration sensor with a seismic mass.

14. A guiding and tensioning device according to claim 1, wherein the at least one actuator is both force creating and acts as a sensor.

15. A guiding and tensioning device according to claim 1, wherein the at least one actuator, acts as a dampening element or as an oscillation absorber, and is passively or semi-actively switched or switch controlled.

16. A guiding and tensioning device according to claim 1, wherein the rail comprises a cantilever supported on the two supports, and the at least one actuator is arranged at the rail between the supports, with the rail includes at least one elastic end in an area of one of the supports.

17. A guiding and tensioning device according to claim 1, wherein the actuator is allocated to a tensioning device that can be stressed mechanically via spring forces or operated hydraulically.

18. A guiding and tensioning device according to claim 1, wherein the rail is made from plastic.
